(19) United States
(12) Patent Application Publication
(10) Pub. No.: US 2003/0126252 A1
(43) Pub. Date: Jul. 3, 2003

(54) Method and apparatus for dynamic client-side load balancing system

(76) Inventor: Eli Abir, South Salem, NY (US)

Correspondence Address: ARNOLD & PORTER, IP DOCKETING DEPARTMENT; RM 1126(b), 555 12TH STREET, N.W., WASHINGTON, DC, 20004-1206, US

(21) Appl. No.: 10/233,734

(22) Filed: Sep. 4, 2002

Related U.S. Application Data
(60) Provisional application No. 60/316,981, filed on Sep. 5, 2001.

(51) Int. Cl. G06F 15/173

(52) U.S. Cl. 709/223

(57) ABSTRACT

A method and apparatus for balancing load among a plurality of server computers connected via a network such as the Internet to a client computer. In one embodiment the invention includes a method of a client computer receiving plurality of addresses associated with a chosen Uniform Resource Locator. The method also includes identifying one of the plurality of addresses as a most recently used address and receiving a Uniform Resource Locator as an entered Uniform Resource Locator. The method further includes identifying the entered Uniform Resource Locator as a chosen Uniform Resource Locator and selecting from the plurality of addresses a selected address that is different from the most recently used address.

### RELATED APPLICATION

The present application claims priority to U.S. provisional application Ser. No. 60/316,981 filed on Sep. 5, 2001, which is hereby incorporated by reference.

### FIELD OF THE INVENTION

This invention relates to a method and apparatus for managing data flow over the Internet or other network environments. In particular, the present invention relates to a client-side application that manages data traffic and reduces the possibility of hacker attacks on computer systems.

### BACKGROUND OF THE INVENTION

The Internet consists of many computers connected together by servers, routers, various communication lines, and other devices. Communication between these computer systems is controlled by common protocols understood by systems from different manufacturers, operating systems, and networking software. A typical data configuration for accessing the Internet involves two parties: a client system and a host system. The user—operating a client computer system—communicates with a desired Internet site by accessing that site's host computer system. As is known to those skilled in the art, the client-host communication system exists on any type of networked computer system.

A common problem for Internet users is the inability to access data provided by host sites. This access problem may be caused by many factors, including poor transmission line quality, improper computer hardware configurations, and improper connections with an Internet Service Provider (ISP). Two main factors preventing consistent user access to host sites caused by the centralized nature of the existing Domain Name System (DNS) are naturally occurring traffic congestion and computer hacker or virus attacks against host sites.

Access problems are exacerbated by the centralized nature of the DNS, the Internet service that translates Internet domain names into appropriate addresses understood by computers connected to the Internet. Most host sites are designated by their domain name: an alphanumeric designation that forms part of a Uniform Resource Locator (URL). Although addresses for Internet sites have logical domain names such as www.microsoft.com, these names are not used to identify the physical location of devices connected to the Internet. Rather, the physical location of devices on the Internet is designated by a numeric format called the Internet Protocol (IP) address that consists of four octets separated by decimals. For example, the web site microsoft.com is mapped to the IP address 207.46.197.100. Since Internet users do not routinely know the IP address for a particular web site, the DNS allows Internet users to access a desired Internet site without knowledge of the particular IP address.

The mapping, or translation, of logical domain names to IP addresses occurs through the use of domain name servers. Domain name servers maintain a table of domain names and matching IP addresses called a DNS Table. Each domain name on the Internet has a specific DNS server or servers that are responsible for maintaining and updating information in their table, and that DNS server is responsible for broadcasting that table confirmation across the Internet.

The typical client-host Internet transaction occurs as follows. Referring to FIG. 1, a typical user, or client, connection to a host Internet site begins with the user typing the domain name for the site into an Internet browser on the client system. If the client has recently accessed the site the IP address may be mapped to the URL in the client's cache. If not, the client system then requests the IP address for the domain name from a local name server. If the local name server has recently received the same request, it may have the IP address. If not, the local name server will request the IP address from a root server. If the first root server does not have the IP address, the name server will request it from another root or local server until the request is fulfilled.

Popular web sites receive a large amount of access requests from users, also known as “hits.” For example, web sites such as microsoft.com and yahoo.com receive millions of visitors each day. Every one of these visits accesses the web site by inputting a URL address in a browser system. Moreover, in most instances these visits are initiated through one IP address (the numerical address corresponding to, for example, microsoft.com and yahoo.com). After the unique URL address (and IP address) is accessed, user requests are often distributed among a group of mirror site servers, each holding identical data to the base server. Distribution in this manner occurs from the use of router hardware and software of the type commonly known in the art. Importantly, these load-balancing techniques occur after a user has accessed the web site by the mapped IP address. Thus, once a user accesses the IP address (registered with the DNS), routers and other server devices operate to distribute the number of users—the “load”—among that site's servers. This load balancing system is designed attempting to allow the maximum number of users to access a site at a given time. The load balancing system is implemented at the entry-level of the web site.

Despite these server-implemented load-balancing solutions, the requirement to have many users access a web site through one IP address before the visits get distributed over the servers hosting the site creates a bottleneck. If too many users are attempting to access one IP address at the same time, the web site will not be accessible to every user.

Moreover, overwhelming an IP address with voluminous access requests can also occur in a malicious manner. With the rapid growth of the Internet, malicious attacks on computer systems connected to the Internet have increased significantly. Many of these attacks are referred to as Denial of Service (DOS) attacks. In DOS attacks, attackers flood the target system, which includes servers, routers, or individual computers, with requests for information at a rate greater than the system is capable of handling. The server or router handling these requests either slows down or becomes completely incapable of functioning. Some attacks compromise multiple host computers and engage these compromised hosts, acting as agents of the attacker, to carry out the attack. This type of attack is known as a Distributed Denial of Service (DDOS) attack. DDOS attacks are more difficult to combat because of the number of sources and resulting amount of Internet traffic that is produced in the attack.

Typical DDOS attack tools include Trin00, Tribe Flood Network (TFN), TFN2K, and Code Red. These attack tools utilize one or more different DOS attacks such as Transmission Control Protocol Synchronize (TCP SYN), Internet Control Message Protocol (ICMP) Flood, User Datagram Protocol (UDP) diagnostic port attack, and Smurf. For example, using the Trin00 tool, the attacker loads a master program on a number of systems often by using a stolen access account. The master program then conducts port scans on large ranges of IP addresses to find vulnerable systems that will be used to carry out the attack. The vulnerable systems identified in the scan are compromised as the Trin00 daemon is loaded onto each. On command of the attacker, the compromised systems run the Trin00 daemon that floods the target with UDP packets directed at random and changing ports on the target system. UDP packets are used to deliver information that requires no response by the destination system. In response to the flood of UDP packets, the system under attack attempts to process each UDP packet according to standard protocols thereby diminishing the system's resources, slowing the system speed, and possibly causing the system to collapse, or crash.

Mutations of these attacks also include the ability to “spoof” or substitute another source IP address rather than including the actual source address in each data packet. Since the source IP address aides in tracking the origin of the attack, spoofing the source address makes it much more difficult to stop a DOS attack by terminating the source.

Prior art solutions to issues involving load balancing and denial of service attacks focus on activities occurring within a specific web site server. As indicated, the most common method to attempt to balance the load of a web site is to use routers and other topology solutions, all occurring on the server side of a client-server transaction. In these schemes, once traffic enters a web site (via an IP address) the server distributes the traffic to multiple other servers (again, with the identical main IP address).

The DNS also offers management of the access issue by use of a “round-robin” distribution system. In a round-robin DNS implementation, a site registers many different IP addresses associated with one domain name. A user requesting access to a site utilizing round-robin DNS is directed to a first IP address. The next user requesting access to the same site (through the common domain name) is directed to a second IP address; and the cycle continues up to the number of IP addresses associated by the DNS with that one domain name. After all IP addresses are utilized, subsequent users are returned to the first IP address. Round-robin DNS is distinguishable from traditional load balancing systems in that traditional load balancing occurs where a site distributes traffic after users enter the site through one IP address.

Round-robin DNS implementations also reside on the centralized DNS and are therefore inadequate to solve the user access issue. Caching on name servers and various features built into the client browser may repeatedly send traffic directly to the IP address, thereby bypassing the round-robin feature. Sites with substantial Internet traffic are queried often and therefore are commonly cached on a local name server or root name server. Therefore, in most instances queries for common web sites using a URL receive the IP address that has been placed in the cache of the various name servers. Caching a URL and the associated IP address across the DNS serves the valuable function of distributing site access queries, but will effectively bypass implementation of the round-robin DNS feature. Again, once the queries are sent to the appropriate IP address, the site owner can obtain load balancing by distributing these requests using routing hardware and software among various host servers. This system, however, remains susceptible to traffic congestion, when large numbers of queries attempt to access the site through one IP address.

In the DDOS situation, devices such as servers and routers are both a means of defending against an attack, as well as a means to propagate an attack when they are commandeered as unintentional hosts for attack programs. Therefore, existing protection measures are also designed to prevent use of systems to propagate attacks in response to approaches used by known attack tools.

For example, many DOS attack tools generate excessive Internet traffic using spoofed IP addresses. To minimize the transmission of packets with an invalid, or spoofed, IP address, routers can be configured to filter outgoing packets allowing only packets with valid source IP addresses to leave. Similarly, to prevent receiving packets with an invalid, or spoofed, IP address, routers can be configured to validate the IP address on incoming packets. While this mechanism will not prevent all denial of service attacks on a system, it prevents a system from being used as a broadcast site in DDOS using known attack tools.

In addition, for systems connected directly to the Internet, consistent network monitoring can protect against port scanning which is used to identify vulnerable systems. While monitoring does not prevent a DOS attack, it can identify vulnerable ports and may lead to the identity of the potential attacker. Continuous monitoring of Internet traffic on host systems can identify a potential problem by comparing traffic statistics to baseline criteria. Similarly, through monitoring, hardware and software firewalls or routers can be used to block known flooding attacks of an IP address such as flooding with ICMP echo commands, or pinging. Firewalls or routers can filter packets entering or leaving a system and deny transit to those failing to meet appropriate criteria. These mechanisms are effective against known attack tools but may not be effective against attack tools developed in the future.

Good security practices and general network housekeeping can prevent or reduce certain types of DOS attacks. Known router and server vulnerabilities may often be resolved by installing security patches. However, since patches are only effective against known vulnerabilities, their effectiveness is limited. Non-essential connections to the Internet can be removed to decrease the likelihood of attack. For example, certain attacks flood UDP and TCP diagnostic ports with requests. One way to protect against floods to these ports is disabling the UDP and TCP diagnostic ports. Again, this protective measure only minimizes the potential for attack by decreasing the number of access points.

Despite existing solutions, utilization of the DNS provides a continuing vulnerability for servers and routers. Since clients utilize a URL to access a web site, and the URL is tied to a limited number of IP addresses that are available publicly over the DNS, the web site remains vulnerable to DOS attacks. While the web site will be able to remove a particular IP address under attack from its pool of IP addresses, this will not alleviate the attack. The attacking requests will simply receive the next IP address associated with the URL that is being distributed by the DNS. As a result, compromised computers will still be able flood the web site's servers with requests, slowing down or disrupting access to the web site. Although the web site will be able to remove and replace an IP address, the attack would simply shift to each subsequent address provided by the DNS.

Each of the aforementioned prior art solutions is a server-side solution that addresses only one facet of the problem caused by resource volume impacting an IP address. Each of these solutions has limitations in its effectiveness. Moreover, current measures such as firewalls, monitoring, and router configuration require a concerted effort among all Internet sites because of the potential for an unprotected system being compromised. Since not all systems connected to the Internet take protective measures to prevent their use as a host site for a DDOS, the protective measures will not be completely effective for any system.

### BRIEF DESCRIPTION OF THE INVENTION

The present invention provides a method and apparatus for balancing load among a plurality of server computers connected via a network to a client computer. The invention includes associating a plurality of addresses with a chosen Uniform Resource Locator (URL) in a client computer and identifying one of the addresses as a most recently used address. The invention also includes receiving a URL as an entered URL and identifying the entered URL as a chosen URL. The method further includes selecting an address corresponding to the chosen URL that is different from the most recently used address. The client computer then accesses a web site or file from a server computer by transmitting a request to the server computer identified in the selected address.

The present invention utilizes a client-side application that dynamically adjusts the IP address used to access the target web site without recourse to the DNS look-up tables. One embodiment of the present invention periodically provides the client with a list of IP addresses used for accessing any target site that uses the invention and directs the user to the selected IP addresses when the user requests the target site's domain name from their Internet browser. Once contacted by the client, the target site using the system can refresh the list of IP addresses as it deems necessary to avoid attack or for any other reason.

The term “client-side” application is not limited to a traditional personal computer-network-server configuration. Thus, the present invention may include any computing device that accesses, through a networked environment, another computing device, including those known to those skilled in the art. The first computing device can be viewed as the “client,” and the second computing device can be viewed as the “server.”

One embodiment of the present invention is a client-side apparatus that allows web site access in a manner that balances the load of incoming requests among an Internet web site's group of servers thereby minimizing the effect of DOS attacks. The embodiment also describes a system for computer communication that allows the client to determine the proper IP address and route Internet traffic to that IP address without resort to any formal domain name servers.

The present invention provides an efficient solution to the load balancing problem associated with too many users attempting to access a web site, identified by one IP address, at a given time. By utilizing a domain name addressing scheme involving a memory cache (or other storage/provision system), the present invention supplies the web browser with a set of appropriate IP addresses. The present invention allows for the periodic renewal and/or replacement of IP addresses to the client computer. The renewal and replacement can be initiated both from the client side, as well as from the server side, once the client has established contact with the server.

One embodiment of the present invention also solves the inadequacy of other DOS and DDOS solutions caused by the need to use the DNS to communicate with a particular Internet site. Unlike the prior art, one embodiment of the present invention utilizes a client-side dynamic destination IP address assignment without reference to the DNS. Access to the site is available to users of the present invention without reference to the DNS, thereby preventing attackers from determining the IP address from the DNS look-up tables and then directing an attack at the listed IP address. In addition, by using a dynamic IP address system, the client prevents hackers and viruses from asserting control over any one IP address and compromising the system through that IP address.

Additionally, one embodiment of the present invention ensures that the source of an attack can be traced to a known user of the client-side application. If an attack is attempted using the present invention, the application allows tracking of the attack. Since all site user entry to the target server will be controlled by the client-side application, the target site will be able to determine the source of an attack and have the ability to extinguish the attack at its source. The prior art solutions to DDOS are not able to determine the actual source of attack because the source address is often spoofed. Moreover, since the present invention controls access to the target Internet site, spoofed addresses cannot be used to attack a site utilizing the present invention. Users without the client-side application can utilize the DNS to attempt to access the site; however, any traffic utilizing IP addresses supplied by the DNS, as noted above, remains vulnerable to congestion, DOS, and other attacks.

### BRIEF DESCRIPTION OF THE DRAWINGS

FIG. 1 illustrates a network in one embodiment of the present invention.

FIG. 2 illustrates a network.

FIG. 3 illustrates a functional block diagram showing a client computer in one embodiment of the present invention.

FIG. 4 illustrates a client-side address file database in one embodiment of the present invention.

FIG. 5 illustrates a method for selecting an address corresponding to an entered URL in one embodiment of the present invention.

### DETAILED DESCRIPTION OF THE INVENTION

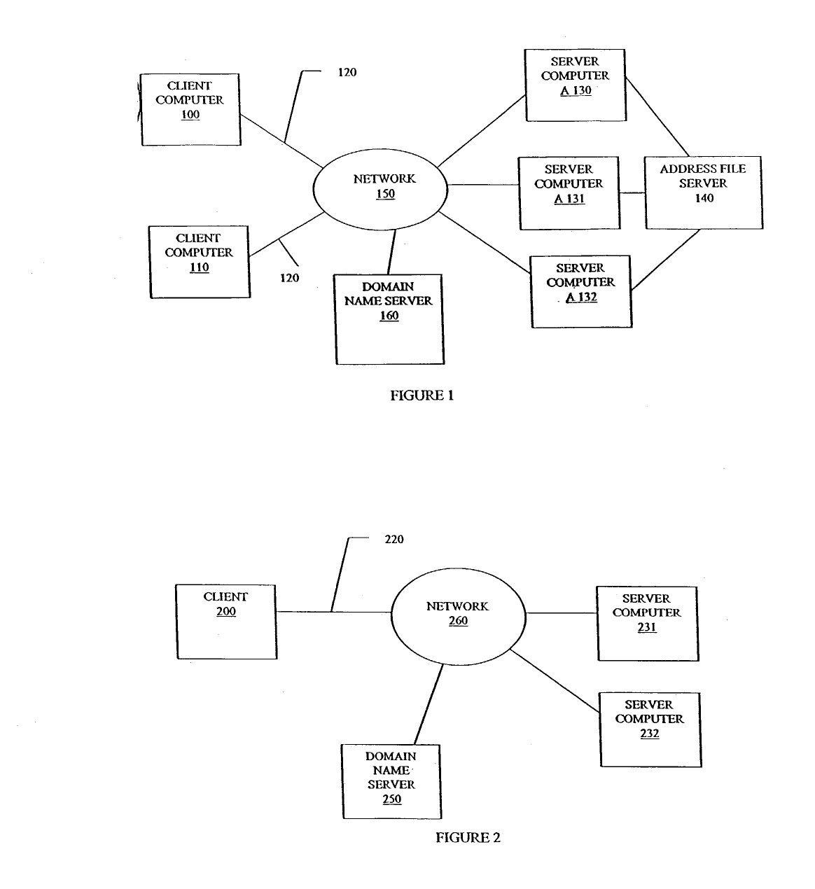

The present invention is directed to a method and apparatus for dynamic client-side load balancing in computer networks, such as the Internet. One embodiment of the present invention can be implemented in a computer system, shown in FIG. 1, comprising a client computer 100 and a client computer 110 connected to a network 150 via a plurality of connections 120. Also connected to network 150 are a plurality of server computers, such as server computer A 130, server computer A 131, and server computer A 132 that are capable of hosting web sites and supplying data and program files to networked client computers 100 and 110. In one embodiment of the present invention, a DNS file server 160 is connected to network 150. In the illustrated embodiment an address file server 140 is connected to server computers A 130, A 131, and A 132.

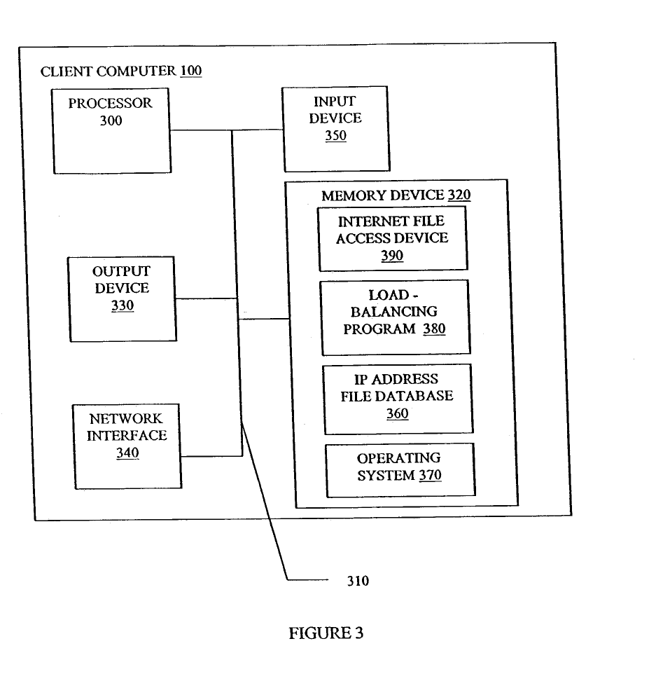

Client computers 100 and 110 are computing devices capable of processing data and communicating with remotely located computers over network 150. For example, FIG. 3 illustrates a client computer 100 comprising a processor 300, which is connected via a bus 310 to a memory device 320, an output device 330 such as a display, a communication device such as a network interface device 340, and an input device 350. During operation of client computer 100, processor 300 communicates with and reads data and programming code stored in memory device 320 via bus 310 to carry out required processing steps. Memory device 320 may be a volatile or non-volatile storage device for storing data and program code. In one embodiment of the present invention, memory device 320 stores at least a portion of an internet file access device 390 during operation of the client computer 100. Internet file access device 390 permits users of client computer 100 to access internet files that are stored on remote server computers. These files can be, for example, data and program files stored on server computers A 130, A 131, and A 132. Internet file access device 390 of the present invention locates and retrieves internet files based on unique file identifiers or addresses that both identify and provide information on the location of particular files.

In one embodiment of the present invention, an address can be derived from a URL address that a user enters into client computer 100 in order to retrieve a web page or to download a file from server computer A 130, A 131, or A 132 without the use of the DNS. For example, a hypothetical URL could be “computer.com/directory/document.” The portion of a URL to the left of the first single forward slash, i.e., “computer.com” identifies a server computer and can be referred to as the server identification portion of the URL. This portion of the URL can be resolved into the IP address of the identified server computer and forms a first part of the address. The portion of the URL to the right of the first single forward slash in the URL, i.e., “directory/document” identifies a particular file stored or hosted on the identified server computer and forms a second portion of the address. This portion of the URL can be referred to as the file identification portion. Thus, the address can comprise two portions: a portion that identifies the computer server on which a file is located, and an optional portion that identifies the particular file and its location on the identified computer server. Where a URL contains no file identification portion, the URL can access a default web page or file that can be referred to as a home page. The associated address for such a URL will only contain a server identification portion.

In one embodiment of the present invention, internet file access device 390 is a web browser program such as Microsoft Internet Explorer or Netscape Navigator. In other embodiments, however, internet file access device 390 may also be an electronic mail programs such as Microsoft Outlook Express, or a file transfer program that retrieve files from remote computers based on the URLs of the files.

Other programs and data files can be stored in memory device 320 in addition to internet file access device 390. These programs and data files can include, for example, an operating system program 370, an address file database 360, and a load-balancing program 380. Load-balancing program 380 reads the URLs entered into internet file access device 390 and returns an address to internet file access device 390, enabling internet file access device 390 to retrieve web pages and files. By recognizing the server identification portion of the URL, load-balancing program 380 can find the IP addresses of server computers A 130, A 131, or A 132 that have copies of the requested file. Load-balancing program 380 then selects and returns the IP address of a different server each time load-balancing program 380 receives a URL with the same server identification portion. Thus, when a user attempts to retrieve files or web pages from a particular web site, the processing load can be shared among the several server computers that host the web site. Moreover, different clients can be assigned different IP lists representing different subsets of the entire list of active IP addresses for server computers hosting common content for a website. This load-balancing system operates in the client computer and may be referred to as a client-side system.

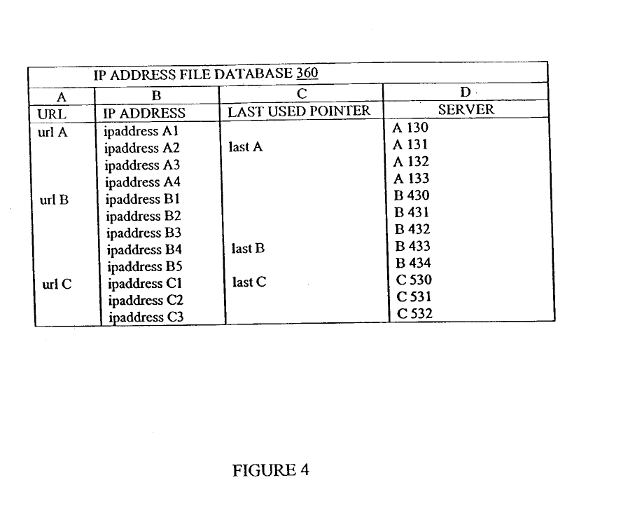

In one embodiment of the present invention, load-balancing program 380 uses and maintains address file database 360 in order to recognize URLs entered into internet file access device 390 and to find the IP addresses of corresponding server computers. An exemplary embodiment of IP address file database 360 is illustrated in FIG. 4 as a database comprising four columns. Column A is a listing of the server identification portions of URLs: urlA, urlB, and urlC. Corresponding to each of these URLs in column B is at least two IP addresses. The IP addresses of server computers corresponding to urlA, for example, can be ipaddressA1 that identifies server computer A 130, ipaddressA2 that identifies server computer A 131, ipaddressA3 that identifies server computer A 132, and ipaddressA4 that identifies yet another server computer A 133 that can be connected to network 150. Similarly, ipaddressB1, ipaddressB2, ipaddressB3, ipaddressB4, and ipaddressB5 are the addresses corresponding to urlB and identify server computers that can be connected to network 150. The addresses ipaddressC1, ipaddressC2, and ipaddressC3 are similarly related to urlC and identify still other server computers. Column C contains pointers identifying an IP address corresponding to each URL that was the most recently used. Thus, the pointer identifies the previously selected addresses, and permits load-balancing program 380 to select a different address when the corresponding URL is entered again. Column D indicates the server computers identified by each IP address. Load-balancing program 380 can be a separate program from internet file access device 390 or, optionally, can be incorporated into and form an integral part of web site access device 390. Similarly, address file database 360 can be separate or integrated with internet file access device 390.

Operating system program 370 provides client computer 100 system with functions that permit processor 300 to control and manage the basic operations of client computer 100. Suitable operating systems include, for example, UNIX, MS-DOS, and Microsoft Windows.

Other features of client computer 100 can include a network interface 340, input device 350, and output device 330. Network interface 340 receives signals sent on bus 310 that are intended for network transmission and converts them to a format suitable to be sent on network 150, and vice versa for signals received from the network 150 that are directed to client computer 100. Thus network interface 340 permits client computer 100 to communicate with remote devices and computers via network 150. In one embodiment of the present invention, input device 350 includes any of a number of devices known to those skilled in the art such as, a keyboard, a touch-sensitive screen, a pointing device such as a mouse, a voice recognition device, or a barcode reader. Users of client computer 100 input instructions and data via input device 350, which are read by processor 300 by means of operating system program 370 for use by other programs and devices as appropriate. Output device 330 presents processed data and other information to users of client computer 100 and is a device such as a display monitor or audio speaker that is known to those of ordinary skill in the art.

As noted above, connection 120 connects client computer 100 to network 150. Connection 120 is any type of scheme used to facilitate data communication to and from client computer 100. For example connection 120 can be an internet connection, such as a dial up connection, cable modem connection, leased line connection, optical connection, or infrared connection that connects computer 100 to the network 150. In one embodiment of the present invention, address file server 140 communicates IP addresses to server computer A 130, A 131, or A 132, which communicate with client computers 100 and 110 through network 150. In another embodiment, address file server 140 can be embedded into the server computers A 130, A 131 and A 132. In another embodiment address file server 140 communicates directly over network 150.

Known name servers resolve ULRLs into IP addresses by transmitting to client computers IP addresses requested in queries. In contrast address file server 140 transmits lists of URLs and corresponding IP addresses to client computers 100 and 110 (through host site computer servers) to update client computer address file database 360. Once client computer 100 makes contact with the server or the address file server 140, the list can be transmitted in response to either a request from client computer 100, or at a time determined by address file server 140 if, for example, IP addresses assigned to URLs have been changed. Address file server 140 can also keep a record of client computer 100 requesting the listing of URLs and IP addresses of server computers A 130, A 131, and A 132. In this way distribution of the IP addresses of server computers A 130, A 131, and A 132 can be monitored and controlled among certain groups of desired users. This provides added protection against hackers. Also, the URL and IP address lists can be transmitted in an encoded or encrypted form so that only intended recipients are able to decrypt and make use of the transmitted IP addresses. In one embodiment of the present invention, the operator of a web site operates address file server 140. Address file server 140 may be physically co-located with server computers A 130, A 131, and A 132. In this embodiment the operator may control how and when IP addresses are released to client computers 100 and 110, either directly or via the server computers once client computers 100 and 110 initiate contact with server computers A 130, A 131, or A 132. In an alternative embodiment address file server 140 can be operated and maintained by a third party load-balancing service provider.

Once client computer 100 or 110 has successfully contacted server computer A 130, A 131, or A 132, the list of IP addresses stored in IP address file database 360 may be refreshed or updated by the direction of either client computer 100 or 110 in one embodiment of the present invention, or server computer A 130, A 131, or A 132 in another embodiment.

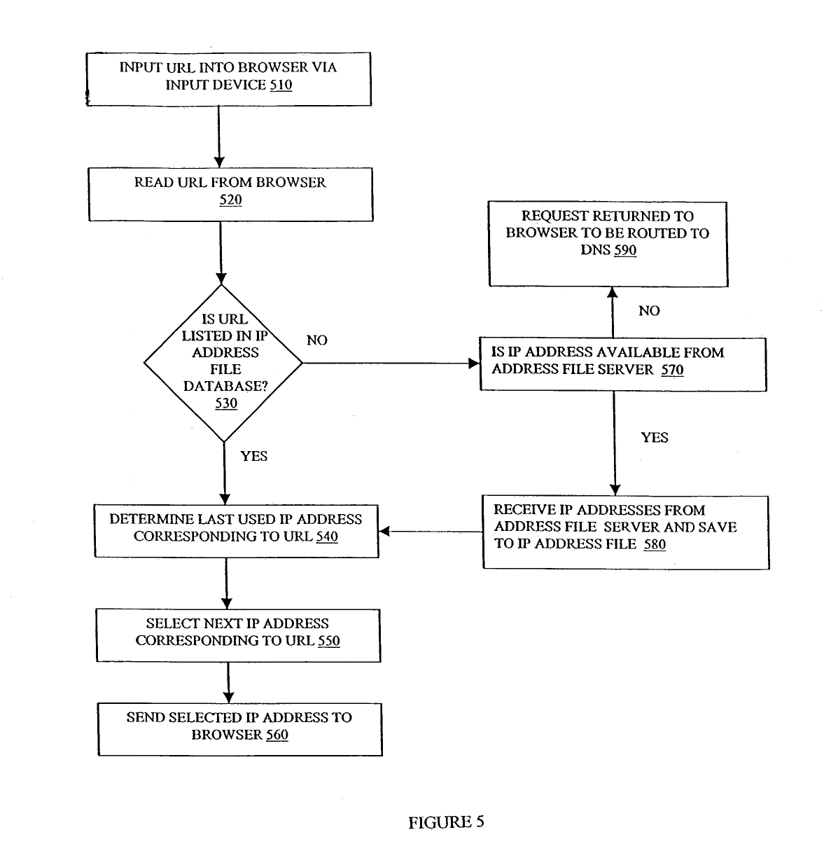

FIG. 5 is a flow chart illustrating the operation of one embodiment of the load balancing method of the present invention. In step 510 a user inputs a URL, for example urlA shown in FIG. 4, into internet file access device 390 or browser via input device 350 in client computer 100. In step 520 internet file access device 390 forwards the entered urlA to load-balancing program 380, which reads the URL. Load-balancing program 380 queries IP address file database 360 in step 530 to determine whether IP addresses are listed that correspond to the server identification portion of urlA. If corresponding IP addresses are located, load-balancing program 380 queries IP address file database 360 in step 540 to determine which IP address was the last to be used. As illustrated in FIG. 4, the last used IP address is ipaddressA2. In step 550 load-balancing program 380 selects a different IP address from the last used ipaddressA2, based on a chosen algorithm. For example, load-balancing program 380 can select the IP address listed immediately following ipaddressA2 in address file database 360. Alternatively, load-balancing program 380 can randomly select from the remaining IP addresses, excluding ipaddressA2. In step 560 load-balancing program 380 appends the IP address to the file identification portion of the URL to form the address, and returns the newly formed address to browser for transmission to the appropriate server computer. For example, if the next selected IP address is ipaddressA3, the browser will receive the IP address for server computer A 132 and send the request to that server.

If in step 530, however, load-balancing program 380 determines that no list of IP addresses corresponding to the server identification portion of the entered URL exists in IP address file database 360, load-balancing program 380 next performs step 570. In this step, a message is transmitted to address file server 140 requesting an update for IP address file database 360. If load-balancing program 380 determines that such updates are not received, step 590 is performed, and a conventional request for the IP address is made to the DNS. In another embodiment, if the answer in step 530 is “no,” the system directly proceeds to step 590 and a conventional request for the IP address is made to the DNS.

As illustrated by FIG. 2, an internet network includes network 260 itself, user computers such as client 200, server computers 230, 231, and 232, and a domain name server 250. Users at client computer 200 access files located on the server computers 230, 231, and 232, by entering the URLs of chosen web sites or files. The client computer 200 forwards a request to a designated name server 250 requesting the IP address corresponding to the entered URL. Designated name server 250 performs a check of its databases to determine whether they contain the requested IP address. If not, designated name server 250 returns the IP address of a domain name server or another name server more likely to be able to satisfy the request. Thus, for example, a user may type the URL of the web site “microsoft.com” into a web site browser on a personal computer. The request to access the web site is transmitted via connector 220 to the server computer hosting the web site, for example, server computer 232, and the web site is accessed over network 260. During the course of this communication, designated name server 250 is accessed to return the IP address corresponding to the logical URL entered into the browser. Designated name server 250 maps the logical URL (microsoft.com) into an IP address (207.46.197.100). In the system illustrated in FIG. 2, designated name server 250 only matches one URL to one IP address; that is, for any one query for a URL presented to domain name server 250, only one IP address corresponding to web site located in server computer 232 is distributed.

In a conventional system a Domain Name Server (DNS) is utilized, either directly or indirectly, to return an IP address for any given resource URL. The correlation between the IP address and the resource URL is fixed; i.e., a logical URL returns the currently mapped IP address when utilizing a DNS.

In one embodiment of the present invention, at least two IP addresses are assigned to a corresponding logical URL utilizing client computer 100 or 110. No DNS is involved, and client computer 100 contains the necessary programs and data to receive a URL and associate that URL with an IP address other than the last used IP address. The conversion process can occur by any common means of data manipulation, so that, for example, the client computer could utilize any appropriate program in conjunction with memory.

Moreover, client computer 100 may rotate the URL through a plurality of IP addresses, providing load balancing directly from the user's computer and protecting against DOS attacks, since different server computers A 130, A 131, and A 132 receive access requests pertinent to a common resource URL. This embodiment reduces the effectiveness of DOS attacks, which rely on a single, publicly accessible, URL/IP address relationship in DNS 160 to overwhelm (by the number of “hits”) server computer A 130, A 131, or A 132, or some other server computer site entry point designated by the DNS.

In another embodiment of the present invention, the available IP addresses may be refreshed in a manner to be determined by a server computer, for example server computer A 130, or any other web site utilizing the present invention. For example, if a URL was associated with a pool of ten IP addresses on client computer 100, and nine of ten IP addresses were corrupted by a computer hacker, assuming ipaddressA1 is the one still in operation, server computer A 130 could transmit a replacement list of IP addresses to client computers 100 and 110 after client computers 100 and 110 initiate contact through the remaining good IP address. Hackers with client computers using ghost IP addresses would not receive the new server computer IP addresses and would be unable to continue attacking the web site hosted on server computer A 130 and the server computers located at the new active IP addresses. The ability to associate these new IP addresses to a particular site, without constant reference and access to the publicly available DNS, minimizes the possibility for immediate corruption.

As will be understood by those skilled in the art, many changes in the apparatus and methods described above may be made by skilled practitioner without departing from the spirit and scope of the invention, which should be limited only as set forth in the claims which follow.

What is claimed is:

1. A method for balancing load among a plurality of server computers, comprising:
associating at a client computer a plurality of addresses with a chosen Uniform Resource Locator;
identifying one of the plurality of addresses as a most recently used address;
receiving a Uniform Resource Locator as an entered Uniform Resource Locator;
identifying the entered Uniform Resource Locator as a chosen Uniform Resource Locator; and
selecting from the plurality of addresses a selected address that is different from the most recently used address.

2 The method of claim 1, further comprising transmitting a request to a server computer identified in the selected address to retrieve a file located in the server computer.

3. The method of claim 1, wherein the plurality of addresses comprise a plurality of Internet Protocol addresses.

4. The method of claim 1, further comprising receiving the plurality of addresses from a remote computer.

5. The method of claim 4, wherein the plurality of addresses are encrypted.

6. The method of claim 4, further comprising sending a request to one of the plurality of server computers to transmit a plurality of addresses associated with the chosen Uniform Resource Locator.

7. The method of claim 4, further comprising decrypting the plurality of addresses.

8. A client computer connected to a plurality of server computers via a network comprising:
a memory device;
a program stored in the memory device; and
a processor adapted to execute the program comprising
associating a plurality of addresses with a chosen Uniform Resource Locator;
identifying one of the plurality of addresses as a most recently used address;
receiving a Uniform Resource Locator as an entered Uniform Resource Locator;
recognizing the entered Uniform Resource Locator as the chosen Uniform Resource Locator; and
selecting one of the plurality of addresses corresponding to the chosen Uniform Resource Locator that is different from the most recently used address.

9. The client computer of claim 8, wherein the processor is adapted to request a file located in one of the plurality of server computers identified in the selected address.

10. The client computer of claim 8, wherein the plurality of addresses comprise a plurality of Internet Protocol addresses.

11. The client computer of claim 8, wherein the processor receives the plurality of addresses associated from a remote computer.

12. The client computer of claim 11, wherein the plurality of addresses are encrypted.

13. The client computer of claim 11, wherein the processor decrypts the plurality of addresses.

14. The client computer of claim 8, wherein the processor sends to one of the plurality of server computers a request to transmit the plurality of addresses that are associated with a single Uniform Resource Locator.
